(19) United States
(12) Patent Application Publication
(10) Pub. No.: US 2018/0166994 A1
(43) Pub. Date: Jun. 14, 2018

(54) Voltage-Regulated Power Converter Module

(71) Applicant: SIEMENS AKTIENGESELLSCHAFT, München (DE)

(72) Inventors: JOERG DORN, BUTTENHEIM (DE); HERBERT GAMBACH, UTTENREUTH (DE); DANIEL SCHMITT, POSTBAUER-HENG (DE); FRANK SCHREMMER, FUERTH (DE); MICHAEL VIETH, NUERNBERG (DE); MARCUS WAHLE, VEITSBRONN (DE); ANDREAS ZENKNER, VEITSBRONN (DE)

(21) Appl. No.: 15/576,334

(22) PCT Filed: May 28, 2015
(86) PCT No.: PCT/EP2015/061907

§ 371 Date: Nov. 22, 2017

(51) Int. Cl. H02M 5/293; H02H 9/04; H02M 7/219; H02M 1/34; H02M 1/42

(52) U.S. Cl. CPC H02M 5/293; H02H 9/04; H02M 2001/348; H02M 1/34; H02M 1/4216; H02M 7/219

(57) ABSTRACT

A voltage-regulated power converter module includes an electrical charge storage device and a semiconductor switch connected thereto and having a collector, a gate and an emitter, in which the collector-emitter path of the semiconductor switch is switched into a current path between first and second alternating-current terminals of the power converter module. The alternating-current terminals can be interconnected through a bypass switch. The voltage-regulated power converter module is intended to minimize the occurrence of damage in the event of a fault, and allow the multilevel power converter to continue operating without possibly having to use an extremely fast bypass switch for this purpose. To this end, the collector and the gate of the semiconductor switch are interconnected through a circuit configuration, which is configured in such a way that it becomes conductive above a predefined voltage threshold. A power converter is also provided.

The invention relates to a voltage-regulated power converter module comprising an electrical charge storage means and a semiconductor switch which is connected thereto and includes a collector, a gate, and an emitter, wherein the collector-emitter path of the semiconductor switch is switched into a current path between a first and a second alternating-current terminal of the power converter module, wherein the alternating-current terminals can be connected via a bypass switch.

Power converters comprising power converter modules of the aforementioned type are utilized nowadays primarily in the case of high-voltage, direct current (HVDC) transmission, which is used, in particular, for power transmission by means of direct current over large distances, generally distances of approximately 750 km and higher. For this purpose, a comparatively high level of technical complexity is required for complex power converters which are suitable for use with high voltage, since electrical energy in power plants is almost always generated by means of synchronous generators as three-phase alternating current having a frequency of 50 Hz or 60 Hz. At and above certain distances, however, HVDC transmission results in lower transmission losses overall than transmission using three-phase alternating current, despite the technical complexity and the additional converter losses involved.

To this end, it is known to utilize current converters which comprise a plurality of series-connected, voltage-regulated power converter modules (voltage-source converters (VSC)) (so-called multilevel power converters). A VSC module is understood to mean a module which comprises a charge storage means as a type of battery, wherein the voltage value at the connections of the module can be varied by appropriately activating semiconductor switches, which are also contained in the module, using a control voltage. With the aid of a series of such VSC modules, it is possible to generate stepped voltage profiles, the step height of which corresponds to the nominal voltage of one of the VSC modules which ultimately form the connection between the alternating-current side and the direct-current side. The use of VSC modules instead of line-commutated converters (LCC), which have been common so far, offers diverse advantages; see G. Gemmell, J. Dorn, D. Retzmann, D. Soerangr, “Prospects of Multilevel VSC Technologies for Power Transmission”, in IEEE Transmission and Distribution Conference and Exposition, Chicago, US, April 2008.

It has proven to be problematic, however, that the large charge storage means utilized in the VSC modules are difficult to control in the event of a fault (for example, switch failure of a semiconductor switch), since the energy is released in an uncontrolled and abrupt manner in this case, in the absence of additional safety measures. In the event of a fault, the electrical components of the electrical circuit are mostly incapable of taking up or controlling the energies. This mostly results in the complete destruction (for example, by means of explosion) of the electrical circuits and, in particular, the charge storage means in the event of a fault. The destruction can also result in further consequential damage to the other operating means. This can be due to electric arcs, enormous magnetic electro-mechanical forces, or even great impurities.

In order to prevent the described worst-case effects, an intrinsically safe fault-limitation must therefore be present in the event of an overvoltage in the installed operating means, which has resulted from a fault condition in the aforementioned manner. With respect to the described multilevel power converters, it is also required that fault events or failures of components, which can be compensated for by means of the built-in redundancy, also be controllable in such a way that a continued operation of the entire system is always ensured.

For this purpose, first of all, in order to minimize the damage and to not unnecessarily contaminate the room around the converter with debris, the semiconductor switches are provided with an explosion protection, so that the semiconductor switches can explode in this casing in the event of a switch failure and due to the enormous energy which is then released at the VSC module level. Due to the explosion cell, no consequential damage is caused to the adjacent modules.

Secondly, a bypass switch is generally provided, which bridges the particular VSC module in the event of a fault. This is required, since the extremely high and rapid voltage changes otherwise result, inter alia, in damage to or destruction of the charge storage means. This is absolutely to be avoided. Since the overcharging of the energy storage means utilized in present-day multilevel power converters can take place in a few milliseconds due to the extremely high operating currents, the bypass switch that is utilized must operate extremely rapidly, in order to suppress or very greatly limit the described fault scenarios.

In order to implement the required closing times in mechanical bypass switches having a high current carrying capacity (for example >1000 A), a mechanical short-circuiter, for example, which is driven by a pyrotechnic propellant charge, is required, as is described, for example, in DE 10 2008 059 670 B3. In this case, the closing delay time is due only to the inertia of the movable current contact and the propagation times of the electronics (a few μs). Any spring-loaded drives, magnetic-relay drives, or any other types of mechanical drives are much too slow and are therefore unsuitable for this application.

The disadvantage thereof, obviously, is the danger associated with the use of the aforementioned pyrotechnic propellant charges.

The problem addressed by the invention is therefore that of providing a voltage-regulated power converter module which minimizes an occurrence of damages in the event of a fault, and allows the multilevel power converter to continue operating without possibly having to use an extremely rapid bypass switch for this purpose.

The problem is solved according to the invention in that the collector and the gate of the semiconductor switch are connected via a circuit arrangement which is designed in such a way that it becomes conductive above a predefined voltage threshold.

The invention is based on the consideration, in this case, that damage to and destruction of the electrical charge storage means is to be avoided when damage occurs to the VSC module in the event of a fault, while damage to or destruction of the semiconductor switches causes a lot less damage and is less complicated to eliminate. The actual semiconductor switches can therefore be utilized for preventing a possible overvoltage in connected charge storage means. The semiconductor switch, at the least, which is situated between the alternating-current terminals of the VSC module is passively connected via a circuit arrangement which lies between the particular collector and the gate of the semiconductor switch and is designed in such a way that it becomes conductive above a predefined voltage threshold. The voltage threshold is matched to the corresponding ignition overvoltage in this case, i.e., it is above the operating voltages by an amount to be determined accordingly and therefore switches the semiconductor switch into the active zone. The thermal destruction of the semiconductor due to the operation in the active zone, which lasts for only a few microseconds, or the thermal destruction of the circuit arrangement due to the long period of energization is intentionally tolerated in this case. The induced transverse ignition initially impedes the overcharging of the charge storage means.

Since the semiconductors switching in normal operation are now utilized for the purpose of overvoltage limitation, the problem of the rapid, intrinsically safe discharge of the energy storage means is solved. Since most of the semiconductors utilized nowadays do not exhibit so-called conduct-on-fail behavior and these semiconductors are practically always completely destroyed by large amounts of energy and extreme power densities during short-circuiting, the longer-term bypass response must still always be accomplished by means of an additional bypass switch. This bypass switch can be designed to be a great deal slower and, therefore, technically simpler than has been the case up to now.

In one advantageous embodiment, the voltage-regulated power converter module is designed as a half-bridge module. Such a module generally comprises only two semiconductor switches, only one of which is situated between the two alternating-current terminals of the VSC module. It is sufficient for the described functionality for this semiconductor switch to be equipped with the above-described circuit arrangement. The term “semiconductor switch” is understood to also mean, in this case, a functional unit of several switches which are connected in parallel, for example in order to increase their performance, but which are always jointly switched, i.e., activated. In this case, the described circuit arrangement must be situated in such a way—depending on the precise configuration of the functional unit—that the functional unit is activated in the event of an overvoltage. To this end, it can be sufficient to open only one of the power switches, for example in the case of a parallel connection of multiple jointly controlled power switches as a functional semiconductor unit. If the gates of the power switches are connected in the functional unit, all the power switches are opened anyway by means of the circuit arrangement.

In one alternative advantageous embodiment, the voltage-regulated power converter module is designed as a full-bridge module or as a clamp double sub module. The latter are known to a person skilled in the art from DE 10 2009 057 288 A1, for example. In such modules, two possible current paths between the two alternating-current terminals are generally present, each of which comprises a plurality of semiconductor switches, each of which includes a collector, a gate, and an emitter. In this case, for at least one of these current paths, for each semiconductor switch whose collector-emitter path has been switched into the current path, the collector and the gate of the particular semiconductor switch are connected via an appropriate circuit arrangement which is designed in such a way that it becomes conductive above a predefined voltage threshold. As a result, it is ensured that the bridging by the semiconductors is ensured via at least one current path.

In yet another advantageous embodiment of the voltage-regulated power converter module, in each semiconductor switch of the module, the collector and the gate of the particular semiconductor switch are connected via an appropriate circuit arrangement which is designed in such a way that it becomes conductive above a predefined voltage threshold. In other words: All the semiconductor switches are provided with the same circuit. As a result, the rapid bridging functions even in the event of failure of the normal gate activation, regardless of which semiconductor switch it is.

Expediently, the particular circuit arrangement includes a suppressor diode or a suppressor diode chain. These have exactly the characteristic required for the application described here, i.e., they become conductive as soon as a certain voltage threshold has been exceeded. By way of an arrangement in a series-interconnected chain, the circuit arrangement can be adapted for almost any voltage.

In fact, the suppressor diodes provide all the required properties, and therefore it suffices that the particular circuit arrangement advantageously consists of the suppressor diode or the suppressor diode chain and does not include any further components.

The electrical charge storage means of the voltage-regulated power converter module is advantageously a capacitor.

The particular semiconductor switch of the voltage-regulated power converter module is advantageously a transistor, in particular a bipolar transistor including an insulated gate electrode (IGBT). This applies, in particular, for each of the semiconductor switches. IGBTs are suitable, in particular, for the application described here in the high-power range, since they have a high off-state forward voltage (current up to 6.5 kV) and can switch high currents (up to approximately 3 kA). In addition, multiple transistors can be connected in parallel in order to switch high currents.

The bypass switch of the voltage-regulated power converter module is advantageously designed as a mechanical switch, for example as a snap switch or an electromagnetic switch. Due to the rapid bridging in the event of a fault via the semiconductor switches themselves, damage to the charge control means is avoided in the manner described and the bypass can be switched via such a slower and less complex switch.

To this end, the voltage-regulated power converter module advantageously includes a control unit for the bypass switch, which is designed in such a way that it closes the bypass switch upon detection of a malfunction of one of the semiconductor switches.

A voltage-regulated power converter module, which is utilized as described for multilevel power converters in HVDC technology, is advantageously designed for a nominal voltage of more than 800 V and/or a nominal voltage of more than 500 A.

A power converter advantageously comprises a plurality of voltage-regulated power converter modules which are series-connected at their particular alternating-current terminals and are designed as described above.

The advantages achieved by way of the invention are, in particular, that, due to the arrangement of a breakdown circuit, in particular a suppressor diode chain between the collector and the gate of a semiconductor switch in a VSC module of a multilevel power converter, in the event of a fault (failure of a single VSC module), a breakdown of the suppressor diode chain takes place and the gate of the correspondingly closed semiconductor is activated. This becomes conductive as a result and the voltage in the energy storage means is limited until an intentional bridge short-circuit takes place by means of the bypass switch. The bypass switch bridges the faulty power electronics until the next maintenance interval. During this time, it is ensured that a permanently closed bypass branch is securely established.

Exemplary embodiments of the invention are described in greater detail on the basis of drawings. In the drawings:

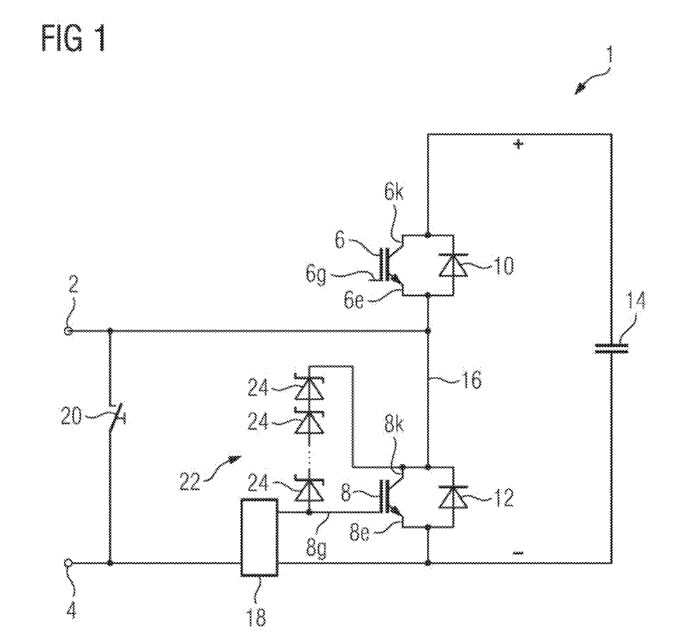

FIG. 1 shows a schematic circuit diagram of a half-bridge VSC module comprising a suppressor diode chain at only one IGBT,

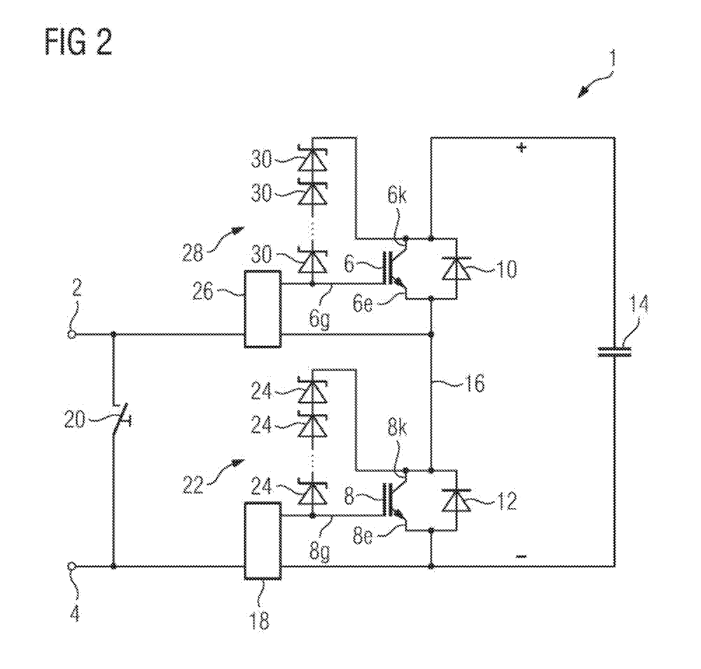

FIG. 2 shows a schematic circuit diagram of a half-bridge VSC module comprising a suppressor diode chain at both IGBTs,

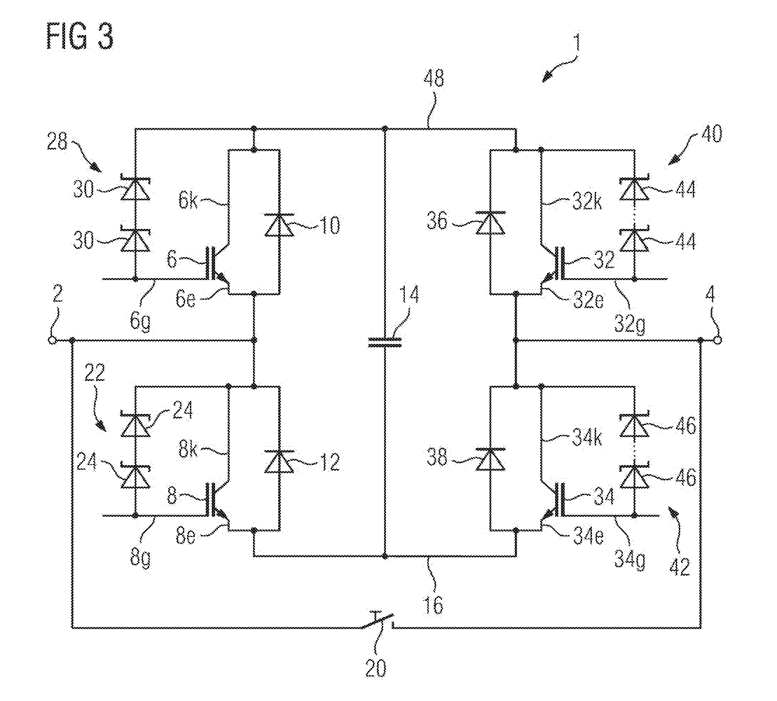

FIG. 3 shows a schematic circuit diagram of a full-bridge VSC module comprising a suppressor diode chain at four IGBTs,

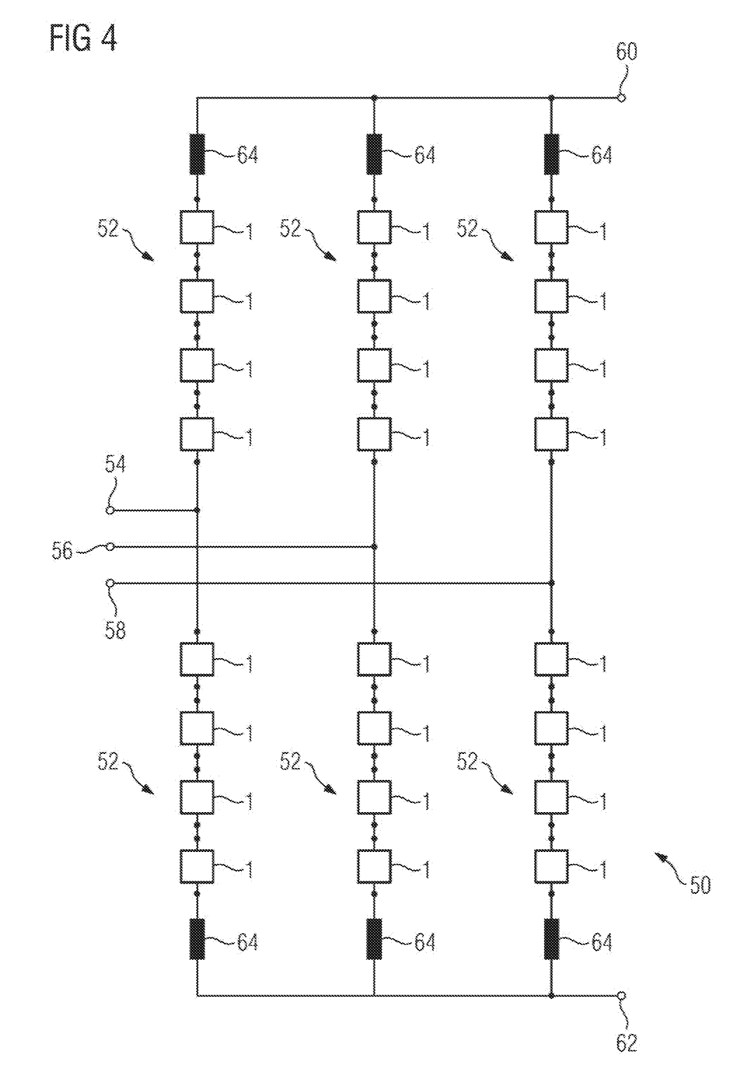

FIG. 4 shows a schematic circuit diagram of a multilevel power converter, and

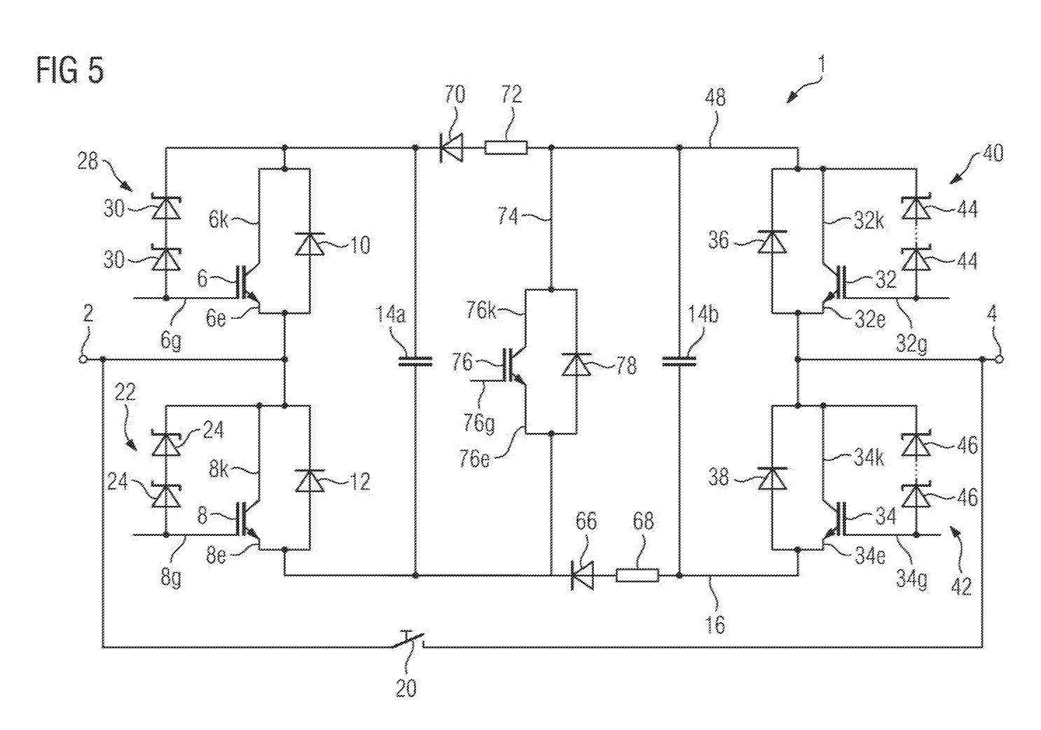

FIG. 5 shows a schematic circuit diagram of a clamp double sub-VSC-module comprising a suppressor diode chain at four IGBTs.

Identical parts are provided with the same reference numbers in all figures.

FIG. 1 shows the circuit diagram of a first exemplary embodiment of a voltage-regulated power converter module 1 in a half-bridge circuit which is comparatively simply designed but is limited in terms of its switching possibilities. The power converter module 1 includes two external alternating-current terminals 2, 4, to which multiple power converter modules 1 are connected in series, as described in greater detail with reference to FIG. 4. In the exemplary embodiment, the power converter module 1 comprises two semiconductor switches 6, 8 in the form of normal-conducting bipolar transistors including an insulated gate electrode (an insulated-gate bipolar transistor (IGBT)), to which a freewheeling diode 10, 12, respectively, is connected contradirectionally in parallel. Other types of transistors can also be used, however, in principle.

In FIG. 1 and in the subsequent drawings, the semiconductor switches 6, 8 are each represented only as individual IGBTs. It goes without saying that this can also be merely representative for multiple IGBTs which form one functional unit, i.e., which are connected in parallel, for example, and the gates of which are connected to each other or are jointly activated.

The semiconductor switches 6, 8 are interconnected with a charge storage means 14 in the form of a capacitor as a central element, in the manner of a half-bridge, i.e., the two semiconductor switches 6, 8 are series-connected in the same direction and, together with the charge storage means 14, form a circuit. The semiconductor switches 6, 8 each comprise a collector 6k, 8k, respectively, a gate 6g, 8g, respectively, and an emitter 6e, 8e, respectively. The first alternating-current terminal 2 is connected to the connection between the emitter 6e of the first semiconductor switch 6 and the collector 8k of the second semiconductor switch 8 of the circuit. The second alternating-current terminal 4 is connected to the connection between the emitter 8e of the second semiconductor switch and the charge storage means 14. The semiconductor switch 8 is therefore connected, via its collector-emitter path, into the current path 16 between the two alternating-current terminals 2, 4.

The semiconductor switches 6, 8 can be activated/switched individually by means of an electronic driver 18. The electronic driver is represented in FIG. 1 only for semiconductor switch 8, for reasons of clarity; the semiconductor switch 6 comprises a similar driver. The driver is capable of switching the connected IGBT on or off with the aid of external control pulses. In one embodiment, a structurally implemented interlock can be provided, which prevents the two semiconductors 6, 8 from switching simultaneously. As a result, the voltage U present at the charge storage means 14 can be switched to the alternating-current terminals 2, 4. Therefore, depending on the switching state of the semiconductor switches 2, 4, the voltage +U or 0 V is present between the alternating-current terminals 2, 4. Any current direction is possible in this case. Due to the series connection of multiple power converter modules 1, a stepped voltage profile can be generated, as is described with reference to FIG. 4.

In the event of a fault of one of the semiconductor switches 6, 8, in particular of the semiconductor switch 8 in this case, an overcharging of the charge storage means 14 can result. The control electronics must detect this rapidly and close a bypass switch 20 which connects the two alternating-current terminals 2, 4. As a result, the power converter module 1 is bridged and the system can continue operating until the next servicing. The bridging must take place very rapidly, however.

In order to ensure that slower mechanical bypass switches 20 can be utilized nevertheless, the collector 8k of the semiconductor switch 8 is connected to the gate 8g via a circuit arrangement 22 which consists of a series of suppressor diodes 24. Therefore, if the voltage between the collector 8k and the gate 8g becomes too great due to the non-activation of the semiconductor switch 8, the suppressor diodes 24 break down and the gate 8g is connected to the voltage at the collector 8g. As a result, a current flow through the semiconductor switch 8 is established, which possibly results in destruction of the semiconductor switch 8 and the suppressor diodes 24, but temporarily prevents destruction of the charge storage means 14 until the bypass switch 20 has been closed. The charge storage means 14 therefore remains intact.

The above-described driver 26 of the semiconductor switch 6 is also represented in a second embodiment of a voltage-regulated power converter module 1 according to FIG. 2, which is described only on the basis of the differences from FIG. 1. In the case of the semiconductor switch 6 as well, the collector 6k is additionally connected to the gate 6g via an identical circuit arrangement 28 which consists of a series of suppressor diodes 30.

FIG. 3 shows yet another exemplary embodiment, specifically the circuit diagram of a power converter module 1 in a full-bridge circuit. In this case as well, the power converter module comprises two alternating-current terminals 2, 4, but four semiconductor switches 6, 8, 32, 34, to each of which, in turn, a freewheeling diode 10, 12, 36, 38, respectively, is connected in parallel for the purpose of protection against an overvoltage during switching-off. The semiconductor switches 32, 34 are designed identically to the semiconductor switches 6, 8 as shown in FIGS. 1 and 2.

The semiconductor switches 6, 8, 32, 34 are interconnected with the capacitor 14 as a central element in the manner of a full bridge, i.e., two semiconductor switches 6, 8 and two semiconductor switches 32, 34 series-connected in the same direction—between which one of the alternating-current terminals 2 or 4, respectively, is situated—are connected to each other and to the capacitor 14 in parallel in the same direction. Therefore, depending on the switching state of the semiconductor switches 6, 8, 32, 34, either +U, −U or 0 V is present between the alternating-current terminals 2, 4. Any current direction is possible in this case.

In the exemplary embodiment in FIG. 3 as well, a bypass switch 20 is provided between the alternating-current terminals 2, 4; the drivers of the semiconductor switches 6, 8, 32, 34 are not represented. In each semiconductor switch 6, 8, 32, 34, the particular collector 6k, 8k, 32k, 34k is connected via an identical circuit arrangement 22, 28, 40, 42 to the particular gate 6g, 8g, 32g, 34g, respectively, each circuit arrangement consisting of a series of suppressor diodes 24, 30, 44, 46.

In the embodiment in FIG. 3, two possible current paths 16, 48 result between the two alternating-current terminals 2, 4. In one alternative embodiment (not shown), it is also possible that only the semiconductors 6, 32 or 8, 34 of a current path 48 or 16, respectively, are provided with the circuit arrangements 28, 40 or 22, 42, respectively.

FIG. 4 shows a schematic representation of an exemplary embodiment of a power converter 50. The power converter 50 comprises six power semiconductor valves 52 which are connected to each other in a bridge circuit. Each of the power semiconductor valves 52 extends between one of the three three-phase current terminals 54, 56, 58 and one of the two direct-current terminals 60, 62.

A three-phase current terminal 54, 56, 58 is provided for each phase of the alternating-voltage network. In the exemplary embodiment shown, the alternating-voltage network is three-phase. The power converter 50 therefore also comprises three three-phase terminals 54, 56, 58. In the exemplary embodiment shown, the power converter 50 is part of a high-voltage direct-current power transmission system and is used for connecting alternating-voltage networks in order to transmit high electrical powers between these networks. It is mentioned at this point, however, that the power converter 50 can also be part of a so-called FACTS system which is utilized for network stabilization or ensuring a desired voltage quality. A use of the power converter 50 in the drive technology is also possible.

Each of the power semiconductor valves 52 in FIG. 4 is identically designed and comprises a series circuit including power converter modules 1 and an inductor 64. The power converter modules 1 are designed according to one of the exemplary embodiments described with reference to one of FIG. 1 to FIG. 3, or according to the exemplary embodiment which is described in the following with reference to FIG. 5.

The embodiment of a power converter module 1 represented in FIG. 5 is designed as a so-called clamp double submodule. It is described with reference to the differences from the embodiment according to FIG. 3.

In the clamp double sub module, the central arrangement and interconnection of the charge storage means 14 from FIG. 3 is essentially changed: In the exemplary embodiment in FIG. 3, i.e., a full-bridge module, the charge storage means 14 is switched into a connecting line between the current path 16 and the current path 48. In the clamp double sub module according to FIG. 5, two separate charge storage means 14a, 14b are initially provided, each of which is switched, in parallel, into a separate connecting line between the current path 16 and the current path 48. A potential isolating diode 66 and a limiting resistor 68 are situated in the current path 16 between the two aforementioned connecting lines comprising the charge storage means 14a, 14b. The current path 48 likewise comprises a potential isolating diode 70 and a limiting resistor 72.

The current path 16 is connected to the current path 48 via a circuit branch 74, in which a further semiconductor switch 76 is situated. This semiconductor switch, as is also the case with the remaining semiconductor switches 76, is designed as an IGBT comprising a corresponding collector 76k, a gate 76g, and an emitter 76e, and connected thereto, contradirectionally in parallel, is a freewheeling diode 78. The driver of the semiconductor switch 76 is not represented, for reasons of clarity.

The circuit branch 74 connects the cathode side of the potential isolating diode 66 to the anode side of the potential isolating diode 70, wherein the limiting resistor 72 situated between the aforementioned anode and the circuit branch 74 was overlooked.

Due to the additional semiconductor 76 in the circuit branch 74 and the resultant additional current paths, the voltage-regulated power converter module 1 according to FIG. 5 allows for a plurality of voltage states at its output terminals, which can be utilized—in particular during fault scenarios of the overall power converter—in order to make it easier to control these fault scenarios. The central, above-described semiconductor switch 76 is not provided with an above-described circuit arrangement, since, in the event of the failure thereof, a discharge of the charge storage means 14a, 14b can also be ensured by means of the remaining semiconductor switches 6, 8, 32, 34. To this end, in a manner similar to that represented in FIG. 3, in each semiconductor switch 6, 8, 32, 34, the particular collector 6k, 8k, 32k, 34k is connected via an identical circuit arrangement 22, 28, 40, 42 to the particular gate 6g, 8g, 32g, 34g, respectively, each of which consists of a series of suppressor diodes 24, 30, 44, 46.

### LIST OF REFERENCE NUMBERS

1 voltage-regulated power converter module
2, 4 alternating-current terminal
6, 8 semiconductor switch
6e, 8e emitter
6g, 8g gate
6k, 8k collector
10, 12 freewheeling diode
14,
14a, 14b charge storage means
16 current path
18 driver
20 bypass switch
22 circuit arrangement
24 suppressor diode
26 driver
28 circuit arrangement
30 suppressor diode
32, 34 semiconductor switch
32e, 34e emitter
32g, 34g gate
32k, 34k collector
36, 38 freewheeling diode
40, 42 circuit arrangement
44, 46 suppressor diode
48 current path
50 power converter
52 power semiconductor valve
54, 56, 58 three-phase current terminal
60, 62 direct-current terminal
64 inductor
66 potential isolating diode
68 limiting resistor
70 potential isolating diode
72 limiting resistor
74 circuit branch
76 semiconductor switch
76e emitter
76g gate
76k collector
78 freewheeling diode

1-13. (canceled)

14. A voltage-regulated power converter module, comprising:
first and second alternating-current terminals defining a current path therebetween;
a bypass switch configured to interconnect said alternating-current terminals;
an electrical charge storage device;
a semiconductor switch connected to said electrical charge storage device, said semiconductor switch including a collector, a gate, an emitter and a collector-emitter path switched into said current path between said first and second alternating-current terminals; and
a circuit configuration interconnecting said collector and said gate of said semiconductor switch, said circuit configuration being configured to become conductive above a predefined voltage threshold.

15. The voltage-regulated power converter module according to claim 14, wherein the voltage-regulated power converter module is a half-bridge module.

16. The voltage-regulated power converter module according to claim 14, wherein:
the voltage-regulated power converter module is a full-bridge module or a clamp double sub module;
said semiconductor switch is one of a plurality of semiconductor switches of said full-bridge module or said clamp double sub module;
each of said semiconductor switches has a collector, a gate, an emitter and a collector-emitter path switched into said current path;
said circuit configuration is one of a plurality of circuit configurations configured to become conductive above a predefined voltage threshold; and
each of said circuit configurations interconnects said collector and said gate of a respective one of said semiconductor switches.

17. The voltage-regulated power converter module according to claim 14, wherein:
said semiconductor switch is one of a plurality of semiconductor switches each having a collector and a gate;
said circuit configuration is one of a plurality of circuit configurations configured to become conductive above a predefined voltage threshold; and
each of said circuit configurations interconnects said collector and said gate of a respective one of said semiconductor switches.

18. The voltage-regulated power converter module according to claim 14, wherein said circuit configuration includes a suppressor diode or a suppressor diode chain.

19. The voltage-regulated power converter module according to claim 14, wherein said circuit configuration is a suppressor diode or a suppressor diode chain.

20. The voltage-regulated power converter module according to claim 14, wherein said electrical charge storage device is a capacitor.

21. The voltage-regulated power converter module according to claim 14, wherein said semiconductor switch is a transistor.

22. The voltage-regulated power converter module according to claim 21, wherein said transistor is a bipolar transistor including an insulated gate electrode.

23. The voltage-regulated power converter module according to claim 14, wherein said bypass switch is a mechanical switch.

24. The voltage-regulated power converter module according to claim 14, which further comprises a control unit for said bypass switch, said control unit being configured to close said bypass switch upon detection of a malfunction of said semiconductor switch.

25. The voltage-regulated power converter module according to claim 14, wherein the voltage-regulated power converter module is constructed for at least one of a nominal voltage of more than 800 V or a nominal current of more than 500 A.

26. A power converter, comprising:
a plurality of voltage-regulated power converter modules according to claim 14 each having respective alternating-current terminals;
said voltage-regulated power converter modules being series-connected at said alternating-current terminals.
